(19) United States
(12) Patent Application Publication
(10) Pub. No.: US 2007/0267103 A1
(43) Pub. Date: Nov. 22, 2007

(54) WOODWORKING MACHINE

(75) Inventors: Michael J. Miller, Gilbert, AZ (US); Kevin Brandon, Flagstaff, AZ (US); Jonathan Mattson, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: UNIQUE MACHINE AND TOOL CO., Phoenix, AZ (US)

(21) Appl. No.: 11/419,124

(22) Filed: May 18, 2006

(51) Int. Cl. B27L 5/04

(52) U.S. Cl. 144/363

(57) ABSTRACT

A woodworking machine and method for performing multiple operations on a workpiece to produce stiles and rails for cabinetry, doors, windows, frames and the like. A first spindle is moveable relative to a fixed workpiece to cut the end of the workpiece. The workpiece is moveable relative to a second spindle to cut the length of the workpiece. A third spindle may be moved simultaneously with said first spindle or separately to cut a second end of the workpiece. The first and third spindles may be coupled to a moveable carriage and passed between to workpieces to simultaneously cut the ends thereof. Alternatively, the first spindle may cut a first workpiece end in a first direction and the third spindle may cut a second workpiece end in a second direction.

### FIELD OF INVENTION

This invention generally relates to automated woodworking machines and methods, and more particularly to a machine and method for performing cutting operations along multiple edges of a workpiece.

### BACKGROUND OF THE INVENTION

Production of cabinet doors, window frames, doors, decorative frames and other similar products generally involves sequential operations to rough size, contour, form, finish size, and attach various components. For example, production of a conventional cabinet door requires multiple cutting operations to form two vertical side pieces or stiles and two horizontal top and bottom pieces or rails that are then joined at their respective ends, surrounding and securing a center panel. The rails and stiles typically have contoured outer or inner edges and the top rail is often formed in an arch corresponding to an arch in the center panel.

Each of the rails and stiles typically includes a groove cut along the length of the inner edge and the rails further include a flange or tenon formed along the two opposing rail ends. The grooves cut along the rail and stile lengths serve to retain the center panel. The grooves along the stile lengths further serve to retain the tenons formed at the ends of the rails when the door is assembled.

Different cutting operations such as groove cuts and tenon cuts are often performed by an operator passing a single workpiece past separate cutters on different machines. This results in inefficient use of production space and requires redundant workpiece setup at each machine and workpiece handling between machines. Various systems and processes have been proposed for combining different operations in a single machine, for example, an operator may move a workpiece sequentially past multiple distinct cutters at a single machine.

For example, the operator may move the workpiece laterally past an end cutter and longitudinally past a profiling cutter at a single machine. Lateral and longitudinal movement of workpieces, compounds the required production space or effective production footprint of the machine, especially for long workpieces. Such machines typically require separate handling and safety equipment and fixtures at each cutter. The inefficiency of these separate fixtures and handling equipment is compounded by the set-up required to process workpieces of varied lengths or widths.

For example, on a conventional double tenoner having two tenon spindles, an operator may move a workpiece laterally past a first tenon spindle, longitudinally or side to side between the two spindles and laterally past the second tenon spindle. The spindles on such doubled tenoners are typically separated by a fixed distance, thus limiting the length of workpiece that may be moved or passed between them. Alternatively, repeated tool set-up may be required to vary the distance between cutting heads for different production widths and lengths. Accordingly, a double tenoner configured for processing longer rails would typically require a large effective production footprint.

Thus, conventional systems are bulky due to lateral and longitudinal movement of workpieces and typically require excessive workpiece handling and tool set-up as the cutting head, fixture, or workpiece is repositioned for successive operations.

Accordingly a need exists for a compact, efficient system and method for performing various cutting operations along multiple edges of workpieces of varied lengths or widths. Similarly, a need exists for a multi-operation woodworking machine having a reduced effective production footprint and for a system and method for reducing the required number, size and cost of related fixtures and handling systems.

### SUMMARY OF THE INVENTION

While the way that the present invention addresses the disadvantages of the prior art will be discussed in greater detail below, in general, the present invention provides a compact automated woodworking machine configured to efficiently perform cutting operations on multiple edges of a workpiece, such as, for example, end cuts at one or both ends of the workpiece and a longitudinal cut along the length of the workpiece. A first cutting spindle cuts a leading end of a workpiece received at a first stage of the machine and a second cutting spindle cuts the trailing end at a second stage after the workpiece is moved between the first and second stages.

Lateral movement of the cutting spindles allows the workpiece to travel primarily longitudinally through the machine, minimizing the effective footprint of the machine. Longitudinal movement of the workpiece between end cuts allows the positioning of the cutting spindles to be independent of the workpiece length. Stated otherwise, this allow workpieces of varied or “infinite length” to be processed without repositioning the cutting spindles or without other re-tooling or repeated set-up by an operator.

In an exemplary woodworking machine, an infeed table (stage 1) and outfeed table (stage 2) are configured to transport and secure a workpiece. A laterally moveable support platform or “carriage” advances cutters past the infeed and outfeed tables to cut the ends of the workpiece. A central conveyer moves the workpiece longitudinally between the infeed table and outfeed table, optionally in contact with a profiling cutter.

Alternative configurations may be used to perform various cutting operations on multiple edges of a single workpiece and/or may be used to perform simultaneous cutting operations on multiple workpieces. For example, the machine may perform one or more end cuts and a longitudinal cut on a single workpiece by advancing a first or second cutter on the moveable carriage past an end of the workpiece and by moving the workpiece longitudinally past another cutter.

Alternatively or additionally, the machine may be used to cut a leading end of a second workpiece on the infeed table simultaneous with a trailing end of a first workpiece on the outfeed table by simultaneously advancing the moveable carriage with the cutters past the workpiece ends. Thus, multiple workpieces of any length may be simultaneously processed by passing a pair of cutters between the ends of the separate workpieces, in contrast to the prior art practice of passing a single workpiece of limited length between a pair of cutters.

The first or second workpieces may be cut along their lengths as they are fed by the central conveyor past a central profiling spindle. For example, a first longitudinal cut may be applied to the inner rail edge and a second longitudinal cut may be applied along the outer edge before, after, or coincident to any longitudinal cut applied to the inner rail edge. Additional operations such as rough-size cuts, finish-length cuts, and jump cuts to prevent tear-out may be performed using additional spindles, cutters or stacked cutting heads.

Encoders may be used at any stage to measure the length or width of the workpiece to inform positioning of the workpiece or machine components, such as a drive mechanism or central conveyer fence. For example, the outfeed table may receive the workpiece from the central conveyor and position the workpiece for a second end cut based on the workpiece length measured at the infeed table. The machine may be networked to an optimizing saw and production length database to optimize use of workpieces of varying lengths produced by the optimizing saw.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures, and

FIG. 1 illustrates a top view of an exemplary woodworking machine according to one embodiment of the present invention with the carriage in the retracted position;

FIG. 2 illustrates a top view of an exemplary woodworking machine according to one embodiment of the present invention with the carriage in the advanced position;

FIG. 3 illustrates a top view of an exemplary infeed table of the woodworking machine of FIG. 1;

FIG. 4 illustrates a top view of an exemplary carriage of the woodworking machine of FIG. 1;

FIG. 5 illustrates a top view of an exemplary outfeed table of the woodworking machine of FIG. 1; and

FIG. 6 illustrates an exemplary operations flowchart according to an exemplary method of use in accordance with various embodiments.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, changes may be made in the function and arrangement of the elements described in these embodiments without departing from the scope of the invention as set forth herein. It should be appreciated that the description herein may be adapted to be employed with alternatively configured devices having different shapes, components, cutters, handling mechanisms, order or number of operations and the like and still fall within the scope of the present invention. Thus, the detailed description herein is presented for purposes of illustration only and not of limitation.

In accordance with various embodiments of the present invention, a woodworking machine performs cutting operations on multiple sides or edges of a workpiece using multiple cutting spindles. The term “spindle” as used herein, refers to any cutting implement and includes rotating cutting heads, stacked cutting heads, chucks for receiving cutting heads, knife cutters, cutoff saws and the like. A tenon spindle is a spindle that forms a flange or a tenon on the workpiece, typically at the end of the workpiece. A profile spindle is typically used to cut or form one of the lengthwise edges of the workpiece. Suitable tenon spindles or profile spindles may include multiple stacked cutters that are moveable for selectively effecting different cuts of varying depth, width, profiles, and the like.

The present invention may be used to form rails, stiles, and similar components used in the production of cabinetry, doors, windows, frames, and the like. That being said, the present invention is described herein in the exemplary context of production of cabinet door rails. Thus, the term “rail” as used herein, generally may be construed to mean any workpiece, including a top rail, bottom rail, hanging stile, shutting stile, lock rail, muntin, casing, jamb, and the like.

Any number or combination of spindles may be used to form the rails. For example, tenon spindles and optionally a profiling spindle may be used to cut two or more sides of a rail. Similarly, a second profiling spindle may be positioned opposite or in series along a first profiling spindle to further form the rail as it is passed through the machine. Similarly, the tenon spindles may be replaced or supplemented with other cutters to rough-size, form or finish-size rails.

Any spindles, actuators, hold downs, fixtures, or other moveable components described herein may be moveable by electric, pneumatic, or hydraulic power or by other means known in the art. The fundamental mechanics and control dynamics of such moveable components are generally known in the art and thus are not discussed in detail herein.

During some operations, in accordance with various embodiments, the rail is held fixed while the spindle is moveable to engage the rail. In various other operations or embodiments, a spindle may be fixed and the rail may be moveable or the spindle or rail may be fixed during one operation and moveable during another. For example, the rail may be initially fixed while the tenon spindle is moved and the rail may then be moved past a fixed profiling spindle. Similarly, a spindle may be used to process a first rail and may be deactivated during processing of a second rail.

One exemplary woodworking machine according to the present invention employs a first spindle to apply a tenon cut to a first end of a rail and a second spindle to cut the second end or one of the longitudinal sides of the rail. For example, a second tenon spindle may apply a tenon cut to a second end of the rail or a profiling spindle may form a longitudinal groove, sometimes referred to as a “rail cut,” along the length of the rail. In various embodiments, both tenon spindles are attached to a common carriage while in other embodiments, the tenon spindles may be supported on separate carriages. Still in other embodiments, a profiling spindle may be moveable with the carriage.

Any combination of spindles or order of operations may be used to process a given rail. For example, a rail may be cut by the first tenon spindle and the profiling spindle, by the first and second tenon spindles, or by the profiling spindle and the second tenon spindle. Thus, it will be understood that various embodiments may include only certain spindles or may activate only certain spindles in different cycles to process rails.

In a preferred double tenoner embodiment, two tenon spindles, a profile spindle and a central conveyor are coupled to a moveable carriage that travels laterally or perpendicular to the longitudinal direction of travel of the rail through the machine. The carriage is advanced and retracted by a drive mechanism along the frame or chassis of the machine. The carriage advances at least one of the tenon spindles in a first movement into engagement with the respective end of a rail secured on the infeed and/or outfeed tables. The carriage aligns the central conveyor with the infeed and outfeed tables to move the rail therebetween past the profiling spindle. Similarly, both tenon spindles may simultaneously cut rails secured respectively on the infeed and outfeed tables as the carriage is advanced or retracted.

Alternatively, the first tenon spindle may cut a first rail as the carriage is advanced and the second tenon spindle may cut a second rail as the carriage is retracted. Alternatively, the first tenon spindle may cut a first end of a rail as the carriage is advanced and the second tenon spindle may cut a second end of the rail as the carriage is retracted or advanced again.

In a preferred double tenoner embodiment, rail movement is limited primarily to longitudinal travel through the machine by moving the tenon spindles past the rails to perform rail end cuts and by moving the rail past the profile spindle to perform longitudinal rail cuts. Reducing or eliminating lateral movement of long workpieces minimizes the effective production footprint of the machine and obviates additional handling systems and safety guards conventionally associated with such movement. The actual machine footprint is minimized by configuring the two tenon spindles for central movement between two rail ends to be cut, in contrast to conventional double tenoners in which a rail is cut between two spaced-apart tenon spindles.

In another exemplary double tenoner embodiment, the two tenon spindles are moveable with the carriage while the central conveyor and/or profiling spindle are fixed relative to the infeed and outfeed tables. Still, in another exemplary embodiment, the tenon spindles are attached to a first moveable carriage and the central conveyor and/or profiling spindle are attached to a second moveable carriage.

Coordination of position sensors, encoders, and controlled drive mechanisms enable the machine to dynamically adjust components to process rails of varied length or width without re-tooling or repeated set-up by an operator. In various embodiments, the infeed and outfeed table include moveable drive mechanisms configured to receive, position and secure individual or multiple rails. The drive mechanism may be retracted to receive multiple workpieces between a table fence and the retracted drive mechanism. Similarly, a moveable fence associated with the central conveyor may be dynamically adjusted to process varying widths as measured by a linear encoder associated with the infeed table.

In an exemplary method of operation of a preferred embodiment, the machine receives rough-cut or “surfaced on four sides” (“S4S”) rails on an infeed table from a hopper or from a handling system associated with a chop saw, optimizing saw, or any other woodworking equipment. A moveable carriage carrying a cutting spindle travels perpendicular to the longitudinal axis of a rail to apply a first tenon cut to the leading end of the rail. The rail travels longitudinally on a central conveyor through the machine in contact with a fixed profiling spindle to form a grooved or contoured inner rail edge. A second alternative profiling spindle may be used to profile the outer rail edge to eliminate the need for costly pre-moulded rail stock. The moveable carriage again travels perpendicular to the workpiece, cutting the second end of the workpiece.

In an extended method according to the preferred embodiment, the outfeed table receives the rail from the central conveyer and positions the rail by reversing the direction of the rail on the outfeed table to cut a predetermined length from the trailing end of the rail. The infeed table simultaneously positions a second rail to be cut at its leading end while the carriage returns to a retracted position. The carriage, carrying the first and a second cutting spindle advances to simultaneously cut the trailing end of the first rail and the leading end of the second rail.

In an exemplary method according to another embodiment, a first rail is received and secured by an infeed table that gauges the width of the first rail. A tenon spindle is then moved forward into engagement with the rail end. A central conveyor and profiling spindle are aligned with the infeed table and an outfeed table. The rail is displaced longitudinally along the profiling spindle by the central conveyor. The rail length is gauged by one or more sensors associated with the infeed table, central conveyor, or outfeed table. For example, a through sensor and feed drive encoder may be used to measure the distance between the leading and trailing ends of a rail. The rail is received, positioned, and secured by the outfeed table. A second tenon spindle is then moved opposite the direction of the first tenon spindle into engagement with the second end of the rail. A second rail may then be positioned and secured on the infeed table and similarly processed on two or more sides.

Thus, it will be appreciated that various embodiments of the woodworking machine of the present invention may be used to individually process single rails, collectively process batches of rails, or to simultaneously process separate rails or batches of rails. For example, the machine may be used to process rails individually or simultaneously by reversing the direction of rotation of the second tenon spindle and/or by changing the timing or sequence of movement of the rail, carriage, or spindles.

The woodworking machine may be networked or otherwise associated with an optimizing saw or chop saw to coordinate input lengths and finished workpiece lengths with various production lengths stored in a production database. The infeed table and outfeed tables may each secure multiple workpieces for simultaneous cutting. The central conveyor may then individually or collectively convey the workpieces between the infeed table and the outfeed table. Multiple workpieces may be simultaneously cut to varied lengths by varied positioning on the infeed or outfeed table. Various embodiments of the machine may process at least up to ten or more rails individually per minute at an average length of eighteen inches per rail.

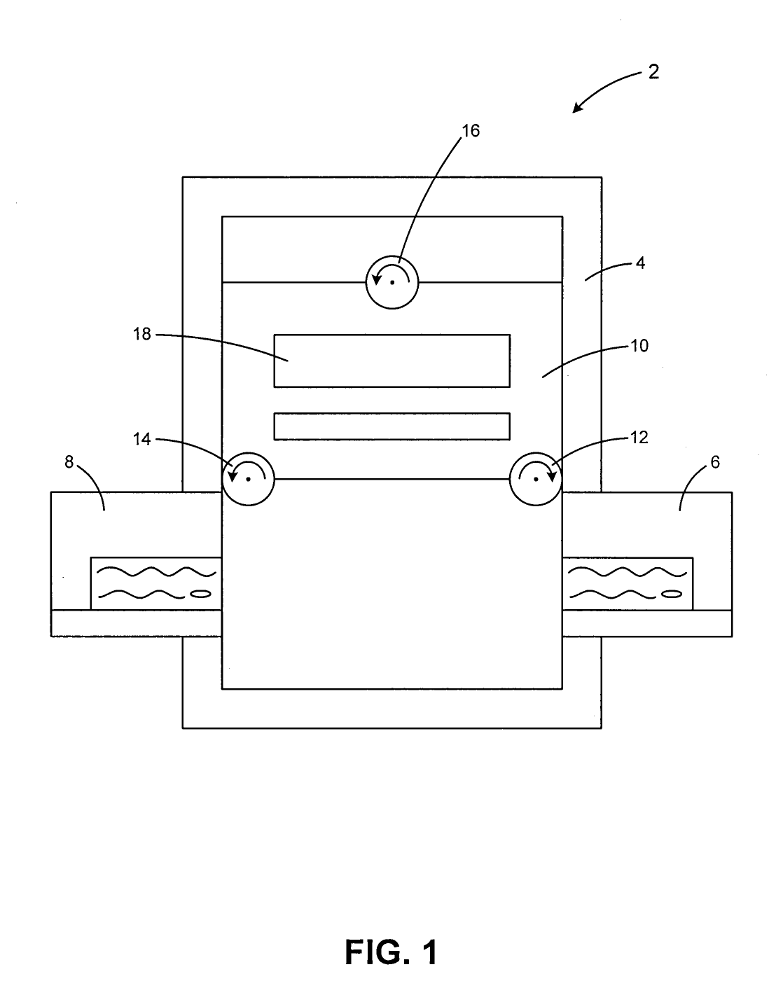

With reference now to FIG. 1, an exemplary woodworking machine 2 according to one embodiment of the present invention includes a chassis 4, an infeed table 6 and outfeed table 8 attached to chassis 4, and a carriage 10 moveable along chassis 4. Chassis 4 may be any structure suitable to support various fixed or moveable components of machine 2. Carriage 10 includes a first tenon spindle 12 adjacent infeed table 6, a second tenon spindle 14 adjacent outfeed table 8, a profiling spindle 16 between spindles 12 and 14 and a central conveyor 18 to conduct rails between tables 6 and 8 past profiling spindle 16.

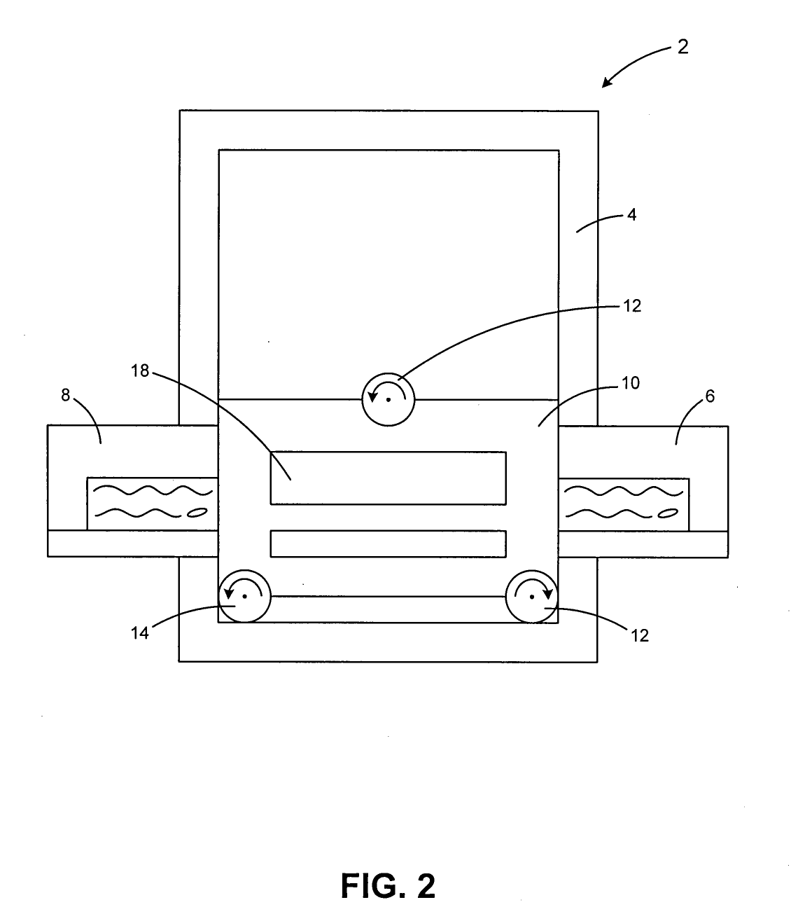

Carriage 10 is moveable from the retracted or pre-cut position shown in FIG. 1 to the advanced post-cut position shown in FIG. 2. Carriage 10 may be any structure moveable relative to chassis 4 and suitable to support spindles 12, 14, and 16 during the respective cutting operations. In various embodiments, Carriage 10 may carry any number or combination of spindles 12, 14, and 16, or rail handling components such as central conveyor 18, or the like. Carriage 10 may be slidably associated with chassis 4 by any suitable track, guide, rail, or the like and may be moved between advanced and retracted positions by means of a ball-screw drive, pressurized cylinder, chain drive, or other suitable drive mechanism.

With reference now to FIG. 2, an exemplary woodworking machine 2 is shown with carriage 10 advanced such that tenon spindles 12 and 14 are in a post-cut position past tables 6 and 8 with central conveyor 18 aligned with tables 6 and 8. As described above, spindles 12 and 14 may be counter-rotating to simultaneously cut ends of two opposed rails as carriage 10 is advanced in a single pass or to cut the two opposed ends of a single rail with two passes of carriage 10. Alternatively, spindles 12 and 14 may rotate the same direction and be alternately or continuously activated such that a first rail end is cut as carriage 10 is advanced and another rail end is cut as carriage 10 is retracted. Similarly, spindles 12 and 14 may be moveable relative to carriage 10 to engage a rail in only one direction of travel of carriage 10.

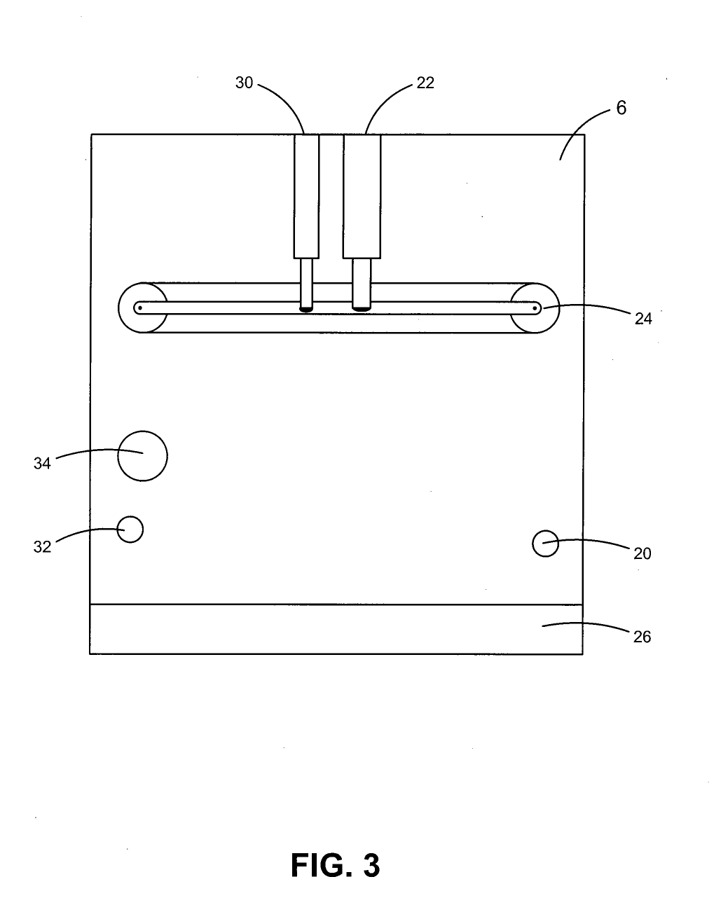

With reference now to FIG. 3, an exemplary infeed table 6 includes a first position sensor 20 communicating with a controller (not shown) for controlling a linear actuator 22 coupled to a feed drive 24. Position sensor 20 may be a through sensor or any other sensor suitable to detect the presence of a rail deposited on infeed table 6. Linear actuator 22 advances from a retracted position upon detection of a rail by sensor 20 until feed drive 24 presses the rail against a guide fence 26.

Linear actuator 22 may be a pneumatic cylinder, screw drive, belt drive or other actuator suitable for advancing and retracting feed drive 24 and providing sufficient pressure for feed drive 24 to displace the rail along fence 26. Linear actuator 22 may be controlled to return to a default retracted position to accommodate rail widths up to the distance between retracted feed drive 24 and fence 26. Alternatively, linear actuator 22 may retract only to accommodate a predetermined rail width. Linear actuator 22 may be further associated with a linear encoder 30 configured to gauge the displacement of linear actuator 22 to measure the width of the rail. Alternatively, linear encoder 30 may be integral to linear actuator 22. Feed drive 24 may include a conveyer belt, drive roller or any other drive mechanism suitable to displace the rail. Feed drive 24 may be configured in any position relative to the rail to suitably advance the rail on infeed table 6.

Fence 26 may be configured as a simple metal stop, or may include roller bearings or various nonstick materials to minimize wear. It is understood that in alternative embodiments, fence 26 may be coupled to linear actuator 22 and feed drive 24 may be fixedly attached to infeed table 6.

After advancement of linear actuator 22, a feed drive controller (not shown) actuates feed drive 24 to advance the rail into position for cutting as determined by a second position sensor 32. Once the rail is positioned, a hold down 34 secures the rail to infeed table 6 with sufficient force to restrain rail movement during engagement with tenon spindle 12. Multiple hold downs 34 may be used to accommodate rails of various widths, multiple rails, or use of sacrificial backers. The number of hold downs 34 actuated in a given cycle may be determined by the rail width, number of rails, or combined rail and backer width. For example, a limit switch or controller may deactivate unneeded hold downs 34 in a given operation. Hold down 34 may be a pneumatic cylinder with a rubber foot, a cantilevered or cammed clamp, a fixture board or any other mechanism suitable to secure the rail.

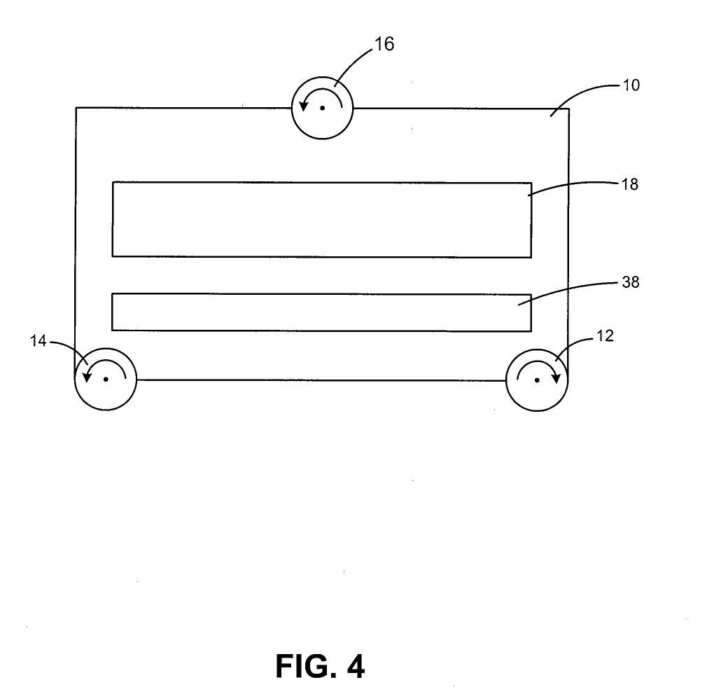

With reference now to FIG. 4, an exemplary carriage 10 is shown, including spindles 12, 14, and 16, central conveyer 18, a carriage table 36 and a carriage fence 38. Carriage fence 38 is configured to maintain the rail in position while in contact with profiling spindle 16. Carriage fence 38 may be automatically adjustable relative to carriage spindle 16 to process the rail width measured by linear encoder 30 on infeed table 6. Alternatively, the position of carriage fence 38 may be set to process the rail to a predetermined production width.

Once the rail is secured on infeed table 6, carriage 10 moves along chassis 4 perpendicular to the length and direction of travel of the rail, advancing tenon spindle 10 into engagement along the leading end of the rail. Carriage 10 then moves as necessary along chassis 4 until central conveyor 18 is aligned with the rail on infeed table 6 or until carriage fence 38 is aligned with fence 26. Central conveyor 18 conducts the rail along carriage table 36 from infeed table 6 to outfeed table 8 in contact with profiling spindle 16. Central conveyor 18 may be a belt drive, a series of powered rollers, or the like. The feed drive controller measures the rail length by recording the distance traveled by feed drive 24 in moving the rail past sensor 32.

In accordance with one variation of this exemplary embodiment, central conveyer 18 and/or spindle 16 may be fixed to chassis 4 in alignment with feed tables 6 and 8. This alternative embodiment may allow for a length cut to be performed between each movement of carriage 10. For example, a pair of counter-rotating spindles may be located adjacent both feed tables 6 and 8 to enable cutting in both directions of travel of carriage 10 simply by engagement of one spindle of each pair in one direction and another in the other direction.

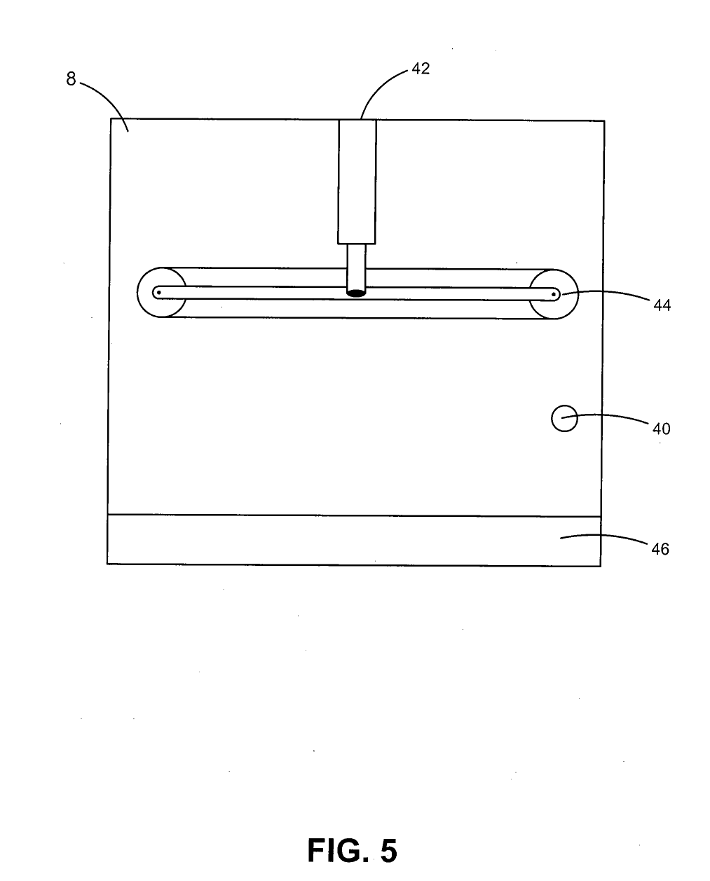

With reference now to FIG. 5, an exemplary outfeed table 8 is shown, similar to infeed table 6, including a position sensor 40 communicating with a feed drive controller (not shown) controlling linear actuator 42 for positioning a feed drive 44 to conduct a rail along a fence 46. As central conveyor 18 deposits the rail onto outfeed table 8, sensor 40 detects the leading end of the rail prompting linear actuator 42 and feed drive 44 to guide the rail along fence 46 until sensor 40 detects the trailing end of the rail. Upon detection of the trailing end of the rail by sensor 40, the feed drive controller reverses the direction of travel of feed drive 44 to return the trailing end of the rail to a position determined as a function of the rail length measured by sensors 32 or 40, or a desired production length provided, for example, by a production database associated with machine 2. Alternatively, a cutoff saw may be substituted for first or second tenon spindles 12 or 14 is some instances.

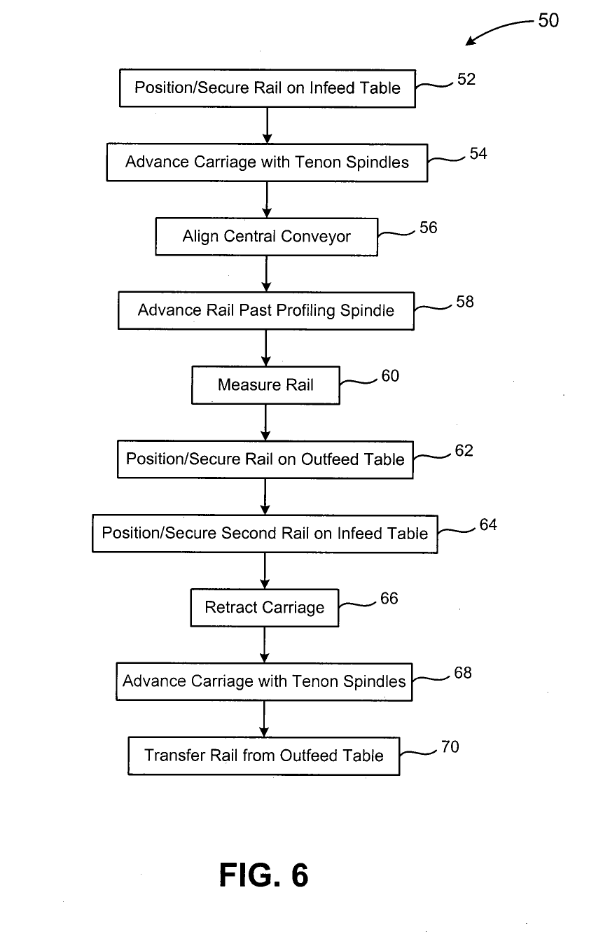

With reference now to FIG. 6, an exemplary method 50 is shown in which a rail is positioned and secured on infeed table 6 (step 52), tenon spindles 12 and 14 are then advanced (step 54) as carriage 10 travels along chassis 4. After advancement of tenon spindles 12 and 14 past infeed and outfeed tables 6 and 8, carriage 10 aligns central conveyer 18 with infeed and outfeed tables 6 and 8 (step 56). Central conveyor 18 then conducts the rail past profiling spindle 16 (step 58), while sensor 30 and the feed drive controller measure the length of the rail (step 60). The rail is then positioned and secured on outfeed table 8 (step 62) while a second rail is positioned and secured on infeed table 6 (step 64) and while carriage 10 returns to the retracted position (step 66). Carriage 10 once again travels forward on chassis 4 to advance tenon spindles 12 and 14 into engagement with rails secured on infeed and outfeed tables 6 and 8 (step 68). It is understood that multiple sides of an individual rail may be processed in each machine cycle and that a second rail need not be simultaneously process with a first rail. Outfeed table then delivers the completed rail, for example to a handling system or operator (step 70).

Thus, it will be appreciated that the relative efficiency of woodworking machine 2 may be increased by performing simultaneous cutting operations on two rails with each pass of carriage 10, but that machine 2 may also operate to perform multiple cuts on a single rail in each cycle. By performing the tenon cuts with the rail positioned outside rather between tenon spindles 12 and 14, rails of varied or “infinite length” may be processed by a compact woodworking machine 2 having a reduced machine footprint. Accordingly, the present invention provides a compact and efficient woodworking machine 2 for performing cutting operations on multiple sides of a workpiece.

Finally, while the present invention has been described above with reference to various exemplary embodiments, many changes, combinations and modifications may be made to the exemplary embodiments without departing from the scope of the present invention. For example, the various spindles and handling components may be combined or implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A woodworking machine comprising:
an infeed table;
an outfeed table;
a moveable carriage positioned between said infeed table and said outfeed table;
a first spindle attached to said carriage adjacent said infeed table; and
a second spindle attached to said carriage adjacent said outfeed table such that movement of said carriage advances at least one of said first spindle and said second spindle into engagement with a workpiece on at least one of said infeed table and said outfeed table.

2. The machine of claim 1, wherein said first spindle is configured to engage a first workpiece on said infeed table and said second spindle is configured to substantially simultaneously engage a second workpiece on said outfeed table.

3. The machine of claim 1, wherein said first spindle is configured to engage a workpiece on said infeed table in a first direction of movement of said carriage and said second spindle is configured to engage a workpiece on said outfeed table in a second direction of movement of said carriage.

4. The machine of claim 1, further comprising a central conveyor configured to convey workpieces between said infeed table and said outfeed table.

5. The machine of claim 4, wherein said central conveyor is attached to said carriage.

6. The machine of claim 4, further comprising a profiling spindle associated with said central conveyor.

7. The machine of claim 1, further comprising a supplemental spindle adjacent one of said first spindle, second spindle, and profiling spindle configured to engage a workpiece substantially simultaneous to said one of said first spindle, second spindle, and profiling spindle.

8. The machine of claim 1, wherein said infeed table comprises:
a sensor configured to detect a workpiece;
a feed drive configured to advance said workpiece to a predetermined position on said infeed table; and
a hold down configured to secure said workpiece in said predetermined position.

9. The machine of claim 8, wherein said infeed table further comprises:
a fence;
a linear actuator configured to urge said workpiece against said fence; and
a linear encoder associated with said linear actuator.

10. The machine of claim 1, wherein said outfeed table comprises:
a sensor configured to detect a workpiece;
a feed drive configured to move said workpiece to a predetermined position on said outfeed table; and
a hold down configured to secure said workpiece in said predetermined position.

11. The machine of claim 1, further comprising:
a central conveyor associated with said carriage, said central conveyor alignable with at least one of said infeed table and said outfeed table by movement of said carriage:
a profiling spindle attached to said carriage adjacent said central conveyor;
a fence associated with said central conveyor and moveable relative to said profiling spindle to cut a workpiece to a predetermined width.

12. The machine of claim 1, further comprising a plurality of cutter heads associated with at least one of said first spindle, second spindle and profiling spindle and wherein said at least one of said first spindle, second spindle and profiling spindle is moveable to bring any one of said plurality of cutter heads into contact with a workpiece.

13. The machine of claim 1, further comprising a jump coping spindle configured to precut a potential tear-out region of a workpiece secured on at least one of said infeed table and said outfeed table.

14. A woodworking machine comprising:
a first spindle moveable substantially perpendicular to the longitudinal axis of a workpiece secured on said machine to cut a first leading end of said workpiece;
a conveyor configured to move said workpiece longitudinally on said machine; and
a second spindle moveable substantially perpendicular to said longitudinal axis of said workpiece to cut a second trailing end of said workpiece.

15. The machine of claim 14, further comprising a third spindle configured to cut the length of said workpiece as said workpiece is moved longitudinally by said conveyor.

16. The machine of claim 14, wherein said first and second spindles are configured to substantially simultaneously cut ends of two separate workpieces secured on said machine.

17. The machine of claim 14, wherein said first spindle moves in a first direction to cut a first end of said workpiece and said second spindle moves in the opposite direction to cut a second end of said workpiece.

18. The machine of claim 15, wherein at least two of said first, second, and third spindles are coupled to a carriage moveable along said machine.

19. The machine of claim 14, further comprising an encoder and a sensor associated with a drive mechanism configured to position said workpiece to be cut to one of a predetermined length and a predetermined width.

20. The machine of claim 19, wherein said drive mechanism is reversible to return said workpiece to a predetermined position relative to said second spindle.

21. The machine of claim 14, further comprising a guide fence and wherein said fence is movable relative to said second spindle to cut said workpiece to a predetermined width.

22. The machine of claim 14, further comprising an infeed table and an outfeed table configured to secure multiple workpieces for simultaneous cutting by at least one of said first and second spindles and wherein said conveyor is configured to move said workpieces individually past said third spindle between said infeed table and said outfeed table.

23. The machine of claim 22, wherein at least one of said infeed table and said outfeed table is further configured to cut said multiple workpieces to different lengths during said simultaneous cutting through varied positioning of said multiple workpieces.

24. A method of forming cuts along multiple sides of a workpiece using a woodworking machine having first and second moveable spindles and a fixed profiling spindle, the method comprising:
receiving a first workpiece at an infeed table;
advancing said first workpiece to a predetermined position on said infeed table;
securing said first workpiece to said infeed table;
cutting the leading end of said first workpiece by advancing said first spindle;
conveying said first workpiece longitudinally from said infeed table to an outfeed table with said first workpiece in engagement with said profiling spindle;
positioning said first workpiece on said outfeed table; and
cutting the trailing end of said first workpiece by moving said second spindle.

25. The method of claim 24, further comprising positioning a second workpiece on said infeed table; and substantially simultaneously cutting the leading end of said second workpiece along with the trailing end of said first workpiece by substantially simultaneously advancing said first spindle and said second spindle.

26. The method of claim 24, further comprising:
networking said woodworking machine to at least one of a cutoff saw and an optimizing saw; and
cutting multiple edges of workpieces of at least one of varying lengths and varying widths without operator intervention.

27. A method of performing multiple cutting operations on a workpiece on a woodworking machine, said method comprising:
moving a first spindle substantially perpendicular to the longitudinal axis of a workpiece secured to said machine to cut a leading end of said workpiece; and
conveying said workpiece longitudinally on said machine in contact with a second spindle to cut the length of said workpiece, such that said workpiece moves substantially exclusively longitudinally on said machine.

28. The method of claim 27, further comprising moving a third spindle relative to said workpiece to cut the second trailing end of said workpiece.

29. The method of claim 28, where said first and third spindles are moved substantially simultaneously.
